(19) United States
(12) Patent Application Publication
(10) Pub. No.: US 2007/0230415 A1
(43) Pub. Date: Oct. 4, 2007

(54) Methods and apparatus for cluster management using a common configuration file

(75) Inventor: Ajay Malik, Santa Clara, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/394,603

(22) Filed: Mar. 31, 2006

(51) Int. Cl. H04Q 7/24

(52) U.S. Cl. 370/338

(57) ABSTRACT

Wireless switches in a cluster are managed by providing a configuration server for storing common configuration files and a DHCP server for storing cluster-specific configuration files corresponding to each cluster. A method for configuring the wireless switches then includes requesting, from the DHCP server, an IP address for the wireless switch; receiving, from the DHCP server, the IP address and the cluster-specific configuration file; receiving, from the configuration server, the common configuration file; and executing, at the wireless switch, the cluster-specific configuration file and the common configuration file.

### TECHNICAL FIELD

The present invention relates generally to wireless local area networks (WLANs) and, more particularly, to management of wireless switch clusters in a WLAN.

### BACKGROUND

In recent years, there has been a dramatic increase in demand for mobile connectivity solutions utilizing various wireless components and wireless local area networks (WLANs). This generally involves the use of wireless access points that communicate with mobile devices using one or more RF channels.

In one class of wireless networking systems, relatively unintelligent access ports act as RF conduits for information that is passed to the network through a centralized intelligent switch, or “wireless switch,” that controls wireless network functions. In a typical WLAN setting, one or more wireless switches communicate via conventional networks with multiple access points that provide wireless links to mobile units operated by end users.

The wireless switch, then, typically acts as a logical “central point” for most wireless functionality. Consolidation of WLAN intelligence and functionality within a wireless switch provides many benefits, including centralized administration and simplified configuration of switches and access points.

In order to provide some form of backup operation in the case of failure, it is possible to include multiple switches in a “cluster.” However, as the number of switches within a cluster increases, the number of configuration files also increases. That is, each wireless switch generally requires a different configuration file, which includes a list of command line interface (CLI) commands to be issued to the switch during set-up. Management of these configuration files can be a time-consuming and complicated task, as it is not unusual for clusters to have 4, 16, or even 256 switches per cluster.

Accordingly, it is desirable to provide a switch configuration scheme that is maintainable and requires low administrative overhead. Other desirable features and characteristics will become apparent from the subsequent detailed description and the appended claims, taken in conjunction with the accompanying drawings and the foregoing technical field and background.

### BRIEF SUMMARY

Wireless switches in a cluster are managed by providing a configuration server for storing common configuration files and a DHCP server for storing cluster-specific configuration corresponding to each cluster. A method for configuring the wireless switches includes requesting, from the DHCP server, an IP address for the wireless switch (e.g., during reboot or startup); receiving, from the DHCP server, the IP address and the cluster-specific configuration; receiving, from the configuration server, the common configuration file; and executing, at the wireless switch, the cluster-specific configuration and the common configuration file. In accordance with one embodiment, the wireless switch also applies a hashing function to the common configuration to produce a hash which is used to ensure that switch in the cluster have the same configuration file.

### BRIEF DESCRIPTION OF THE DRAWINGS

A more complete understanding of the present invention may be derived by referring to the detailed description and claims when considered in conjunction with the following FIGURES, wherein like reference numbers refer to similar elements throughout the FIGURES.

FIG. 1 is a conceptual overview of an exemplary wireless network with a three-switch cluster.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

Various aspects of the exemplary embodiments may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements and/or the like, which may carry out a variety of functions under the control of one or more microprocessors or other control devices. In addition, the present invention may be practiced in conjunction with any number of data transmission protocols and that the system described herein is merely one exemplary application for the invention.

For the sake of brevity, conventional techniques related to signal processing, data transmission, signaling, network control, the IEEE 802.11 family of specifications, and other functional aspects of the system (and the individual operating components of the system) may not be described in detail herein. Furthermore, the connecting lines shown in the various FIGURES contained herein are intended to represent example functional relationships and/or physical couplings between the various elements. It should be noted that many alternative or additional functional relationships or physical connections may be present in a practical embodiment.

Without loss of generality, in the illustrated embodiment, many of the functions usually provided by a traditional wireless access point (e.g., network management, wireless configuration, and the like) can be concentrated in a corresponding wireless switch. It will be appreciated that the present invention is not so limited, and that the methods and systems described herein may be used in the context of other network environments, including any architecture that makes use of client-server principles or structures.

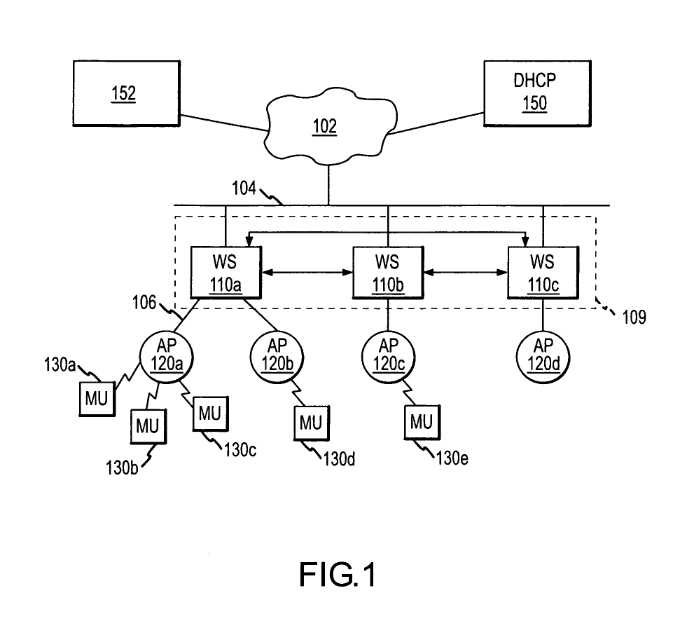

Referring now to FIG. 1, one or more switching devices 110 (alternatively referred to as “wireless switches,” “WS,” or simply “switches”) are coupled via one or more networks 104 (e.g., an Ethernet or other local area network coupled to one or more other networks or devices, indicated by network cloud 102). One or more wireless access ports 120 (alternatively referred to as “access ports” or “APs”) are configured to wirelessly connect switches 110 to one or more mobile units 130 (or “MUs”) after a suitable AP adoption process. APs 120 are suitably connected to corresponding switches 110 via communication lines 106 (e.g., conventional Ethernet lines). A dynamic host configuration protocol (DHCP) server 150 (or other functionally equivalent server) is coupled to network 102, as is a configuration server 152—both of which are described in further detail below.

Any number of additional and/or intervening switches, routers, servers and other networks or components may also be present in the system. Similarly, APs 120 may have a single or multiple built-in radio components. Various wireless switches and access ports are available from SYMBOL TECHNOLOGIES of San Jose, Calif., although the concepts described herein may be implemented with products and services provided by any other supplier.

A particular AP 120 may have a number of associated MUs 130. For example, in the illustrated topology, MUs 130(a), 130(b) and 130(c) are logically associated with AP 120(a), while MU 130(d) is associated with AP 120(b). Furthermore, one or more APs 120 may be logically connected to a single switch 110. Thus, as illustrated, AP 120(a) and AP 120(b) are connected to WS 110(a), and AP 120(c) is connected to WS 110(b). Again, the logical connections shown in the FIGURE are merely exemplary, and other embodiments may include widely varying components arranged in any topology.

Each AP 120 establishes a logical connection to at least one WS 110 through a suitable adoption process. In a typical adoption process, each AP 120 responds to a “parent” message transmitted by one or more WSs 110. The parent messages may be transmitted in response to a request message broadcast by the AP 120 in some embodiments; alternatively, one or more WSs 110 may be configured to transmit parent broadcasts on any periodic or aperiodic basis. When the AP 120 has decided upon a suitable “parent” WS 110, AP 120 transmits an “adopt” message to the parent WS 110.

Following the adoption process, each WS 110 determines the destination of packets it receives over network 104 and routes that packet to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. Equivalent embodiments may provide additional or different functions as appropriate.

Wireless switches 110A-C are shown in FIG. 1 as being combined into a single cluster 109 to provide backup and redundancy as appropriate. That is, if one or more switches 110A-C were to become unavailable for any reason, then one or more other switches 110 in the cluster 109 would automatically absorb some or all of the functions previously carried out by the unavailable switch 110, thereby continuing service to mobile users 130 in a relatively smooth manner. In practice, clusters could be formed from any grouping of two or more wireless switches 110 that are assigned any number of licenses. A simple cluster could be made up of a primary switch 110 and a dedicated backup, for example, in which case the backup may be assigned zero (or relatively few) licenses. Alternatively, any number of active switches could provide redundancy for each other, provided that they are able to intercommunicate through networks 104 and/or 102. The cluster 109 made up of switches 110A-C, then, would allow any switch 110 in the cluster to absorb functions carried out by any other switch 110 if the other switch 110 were to become unavailable.

Redundancy is provided in any manner. In various embodiments, switches 110A-C making up a cluster 109 suitably exchange adoption information (e.g. number of adopted ports, number of licenses available, etc.) as appropriate. This data exchange may take place on any periodic, aperiodic or other basis. In the event that wireless switch 110A in FIG. 1, for example, would become unavailable, switches 110B and 110C may have ready access to a relatively current routing list that would include information about APs 120A-B and/or MUs 130A-D previously associated with switch 110A. In such embodiments, either switch 110B-C may therefore quickly contact APs 120A-B following unavailability of switch 110A to take over subsequent routing tasks. Similarly, if switches 110B or 110C should become unavailable, switch 110A would be able to quickly assume the tasks of either or both of the other switches 110B-C. In other embodiments, the remaining switches 110 do not directly contact the APs 120 following the disappearance of another switch in the cluster, but rather adopt the disconnected APs 120 using conventional adoption techniques.

Clusters may be established in any manner. Typically, clusters are initially configured manually on each participating WS 110 so that each switch 110 is able to identify the other members of the cluster 109 by name, network address or some other identifier. When switches 110A-C are active, they further establish the cluster by sharing current load information (e.g. the current number of adopted ports) and/or other data as appropriate. Switches 110A-C may also share information about their numbers of available licenses so that other switches 110 in cluster 109 can determine the number of cluster licenses available.

During operation of the cluster 109, each switch 110A-C suitably verifies the continued availability of the other switches 110. Verification can take place through any appropriate technique, such as through transmission of regular “heartbeat” messages between servers. In various embodiments, the heartbeat messages contain an identifier of the particular sending switch 110. This identifier is any token, certificate, or other data capable of uniquely identifying the particular switch 110 sending the heartbeat message. In various embodiments, the identifier is simply the media access control (MAC) address of the sending switch 110.

MAC addresses are uniquely assigned to hardware components, and therefore are readily available for use as identifiers. Other embodiments may provide digital signatures, certificates or other digital credentials as appropriate, or may simply use the device serial number or any other identifier of the sending switch 110. The heartbeat messages may be sent between switches 110 on any periodic, aperiodic or other temporal basis. In an exemplary embodiment, heartbeat messages are exchanged with each other switch 110 operating within cluster 109 every second or so, although particular time periods may vary significantly in other embodiments. If a heartbeat message from any switch 110 fails to appear within an appropriate time window, another switch 110 operating within cluster 109 adopts the access ports 120 previously connected with the non-responding switch 110 for subsequent operation.

In accordance with the present invention, and consistent with Network Working Group RFC 2132, the DHCP client (wireless switch 110) includes option 60 and option 61 in DHCP messages sent to DHCP server 150, and DHCP server 150 includes option 43 in the DHCP messages to the client 110. As per RFC 2132, this option 60 is used by DHCP clients to optionally identify the vendor type and configuration of a DHCP client. The information is a string of n octets, which is interpreted by the server. Vendors may choose to define specific vendor class identifiers to convey particular configuration or other identification information about a client. For example, the identifier may encode the client's hardware configuration. Servers not equipped to interpret the class-specific information sent by a client must, in accordance with RFC 2132, ignore it (although it may be reported).

Servers that respond should only use option 43 to return the vendor-specific information to the client, while option 61 is used by DHCP clients to specify their unique identifier. DHCP servers use this value to index their database of address bindings. This value is expected to be unique for all clients in an administrative domain. In accordance with option 60, wireless switch 110 identifies itself by a unique ASCII name, and DHCP server 150 is configured to return an option 43 response for this unique ASCII name received as part of option 60.

In DHCP server 150, for option 43, the response has multiple items of information encoded as multiple sub-options. In accordance with one aspect of the invention, a new sub-option 216 has been defined to carry all cluster information within this option 43. This sub-option 216 includes a list of IP addresses for each member of the cluster and the cluster-specific configuration of CLI commands for each member of the cluster.

Configuration server 152 stores one or more common configuration files which, again, are typically lists of CLI commands to be issued to the wireless switch. The common configuration files include commands that are used for set-up of all wireless switches on the network, regardless of cluster membership. Configuration server 152, which may be any suitable type of networked host, is configured to send to each of the plurality of wireless switches 110 the appropriate common configuration file in response to a request.

Given the above system, where the common configuration file is stored separately from the cluster-specific configuration files, operation proceeds as follows. A wireless switch 110 connected to network 104 is powered on (or rebooted), at which time it requests from DHCP server 150 an IP address. In response, DHCP server transmits to wireless switch 110 an IP address (e.g., IP address that will be used until next rebooting or power up) and a cluster-specific configuration information as sub-option 216 encoded in option 43.

Switch 110 also receives information regarding the location of configuration server 152 (e.g., its IP address) as another sub-option in option 43 and then it requests from configuration server 152 a common configuration file. In response, configuration server 152 sends the common configuration file to the switch. Switch 110 then executes both the common configuration file and the cluster-specific configuration commands to complete setup.

In accordance with one embodiment, switch 110 applies a hashing function (e.g., an MD5 hashing function) to the common configuration file and stores the resulting hash value. This hash value can then be used to verify that the switch can participate in the cluster—e.g., only switches with the same has value and cluster-specific configuration file are allowed to join the cluster.

In accordance with the above, an administrator only needs to manage a single configuration file (i.e., the common configuration file), greatly reducing administrative costs and memory requirements.

The particular aspects and features described herein may be implemented in any manner. In various embodiments, the processes described above are implemented in software that executes within one or more wireless switches 110. This software may be in source or object code form, and may reside in any medium or media, including random access, read only, flash or other memory, as well as any magnetic, optical or other storage media. In other embodiments, the features described herein may be implemented in hardware, firmware and/or any other suitable logic.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A method for configuring a wireless switch within a cluster, the method comprising:
requesting, from a dynamic host configuration protocol (DHCP) server, an IP address for the wireless switch;
receiving, from the DHCP server, the IP address and a cluster-specific configuration file in response to the requesting step;
requesting, from a configuration server, a common configuration file;
receiving, from the configuration server, the common configuration file; and
executing, at the wireless switch, the cluster-specific configuration file and the common configuration file.

2. The method of claim 1, wherein said step of requesting an IP address occurs when operation of the wireless switch is initiated.

3. The method of claim 1, further including receiving, from the DHCP server, information specifying an address of the configuration server.

4. The method of claim 1, wherein the IP address of the wireless switch is received from the DHCP server.

5. The method of claim 1, further including applying a hash function to the common configuration file to produce a hash, and storing the hash at the wireless switch.

6. A network management system for managing a plurality of wireless switches configured in a cluster, the system comprising:
a dynamic host configuration protocol (DHCP) server having a set of cluster-specific configuration files stored therein, the DHCP server configured to send to each of the plurality of wireless switches an IP address and one of the cluster-specific configuration files in response to an IP address request;
a configuration server having a common configuration file stored therein, the configuration server configured to send to each of the plurality of wireless switches the common configuration file in response to a common configuration file request;

7. The system of claim 6, wherein the DHCP server stores a list of clusters and, for each cluster, a cluster-specific configuration file and a list of IP addresses corresponding to each cluster.

8. The system of claim 6, wherein the common configuration file and the cluster-specific configuration file contain command line interface (CLI) commands associated with the plurality of wireless switches.

9. The system of claim 6, wherein the wireless switches are configured to apply a hash function to the common configuration file to produce a hash.

10. The system of claim 6, wherein the wireless switches are configured to issue an IP address request to the DHCP upon start-up or reboot.

11. The system of claim 6, wherein the common configuration file and the cluster-specific configuration file are lists of command line interface (CLI) commands.

12. The system of claim 6, wherein the configuration server is a server of a type selected from the group consisting of FTP, TFTP, HTTP, and SCP.
